(19) United States
(12) Patent Application Publication
(10) Pub. No.: US 2024/0030405 A1
(43) Pub. Date: Jan. 25, 2024

(54) COMPOSITE ELECTRODES

(71) Applicant: GM GLOBAL TECHNOLOGY OPERATIONS LLC, Detroit, MI (US)

(72) Inventors: Meixian WANG, Troy, MI (US); Michael P. BALOGH, Novi, MI (US); Ion C. HALALAY, Grosse Pointe Park, MI (US); Insun YOON, Troy, MI (US)

(73) Assignee: GM GLOBAL TECHNOLOGY OPERATIONS LLC, Detroit, MI (US)

(21) Appl. No.: 17/869,389

(22) Filed: Jul. 20, 2022

(51) Int. Cl. H01M 4/36; H01M 4/485; H01M 4/587

(52) U.S. Cl. CPC H01M 4/364; H01M 4/485; H01M 4/587; H01M 2004/021

(57) ABSTRACT

The present disclosure provides a composite electrode for an electrochemical cell that cycles lithium ions. The composite electrode includes a first electroactive material having a first specific capacity and a first average particle size, and a second electroactive material having a second specific capacity and a second average particle size. The first specific capacity is larger than the second specific capacity. For example, the first specific capacity can be greater than or equal to about 1,000 mAh/g to less than or equal to about 3,600 mAh/g, and the second specific capacity greater than or equal to about 250 mAh/g to less than or equal to about 400 mAh/g. The second average particle size is comparable with the first average particle size. For example, the second average particle can be no less than half the first average particle size and no greater than twice the first average particle size.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12 V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. The negative electrode typically includes a lithium insertion material or an alloy host material. For example, typical electroactive materials for forming an anode include graphite and other forms of carbon, silicon and silicon oxide, tin, and tin alloys. Certain anode materials have particular advantages. While graphite having a theoretical specific capacity of 372 mAh·g⁻¹ is most widely used in lithium-ion batteries, anode materials with high specific capacity, for example high specific capacities ranging about 900 mAh·g⁻¹ to about 4,200 mAh·g⁻¹, are of growing interest. For example, silicon has the highest known theoretical capacity for lithium (e.g., about 4,200 mAh·g⁻¹), making it an appealing material for rechargeable lithium ion batteries. Such materials, however, are often susceptible to huge volume expansion during lithiation and delithiation, which can lead to particle pulverization, loss of electrical contact, and unstable solid-electrolyte interface (SEI) formation, causing electrode collapse and capacity fading. Accordingly, it would be desirable to develop improved materials, and methods of making and using the same, that can address these challenges.

### SUMMARY

This section provides a general summary of the disclosure, and is not a comprehensive disclosure of its full scope or all of its features.

The present disclosure relates to composite electrodes including two or more electroactive materials having comparable particle sizes, and to methods of making and using the same.

In various aspects, the present disclosure provides a composite electrode for an electrochemical cell that cycles lithium ions. The composite electrode may include a first electroactive material having a first specific capacity and a first average particle size, and a second electroactive material having a second specific capacity and a second average particle size. The first specific capacity may be larger than the second specific capacity. For example, the first specific capacity may be greater than or equal to about 1,000 mAh/g to less than or equal to about 3,600 mAh/g, and the second specific capacity greater than or equal to about 250 mAh/g to less than or equal to about 400 mAh/g. The second average particle size may be comparable with the first average particle size. For example, the second average particle may be no less than half the first average particle size and no greater than twice the first average particle size.

In one aspect, the first average particle size may be greater than or equal to 5 micrometers to less than or equal to about 12 micrometers, and the second average particle size may be greater than or equal to about 8 micrometers to less than or equal to about 16 micrometers.

In one aspect, the composite electrode may include greater than or equal to about 10 wt. % to less than or equal to about 80 wt. % of the first electroactive material, and greater than or equal to about 20 wt. % to less than or equal to about 90 wt. % of the second electroactive material.

In one aspect, the second electroactive material may include a first plurality of second electroactive material particles and a second plurality of second electroactive material particles. The second electroactive material particles defining the first plurality of second electroactive material particles may have the second average particle size, and the second electroactive material particles defining the second plurality of second electroactive material particles may have a third average particle size that is greater than the first and second average particles sizes.

In one aspect, the third average particle size may be greater than or equal to about 14 micrometers to less than or equal to about 30 micrometers.

In one aspect, the composite electrode may include greater than or equal to about 10 wt. % to less than or equal to about 40 wt. % of the first electroactive material, greater than or equal to about 10 wt. % to less than or equal to about 40 wt. % of the second electroactive material particles defining the first plurality of second electroactive material particles, and greater than or equal to about 20 wt. % to less than or equal to about 80 wt. % of the second electroactive material particles defining the second plurality of second electroactive material particles.

In one aspect, the first electroactive material may include a silicon-containing electroactive material.

In one aspect, the silicon-containing electroactive material may be selected from the group consisting of: SiOₓ (where 0≤x≤2), LiₓSiO (where 0≤x≤2), nanosized silicon-carbon composite, and combinations thereof.

In one aspect, the second electroactive material may include a carbonaceous-based electroactive material.

In one aspect, the carbonaceous-based electroactive material may be selected from the group consisting of: natural graphite, synthetic graphite, and combinations thereof.

In one aspect, the first electroactive material may include a first plurality of first electroactive material particles and a second plurality of first electroactive material particles. The first electroactive material particles defining the first plurality may have the first average particle size, and the first electroactive material particles defining the second plurality may have a third average particle size that is smaller than the first and second average particle sizes.

In one aspect, the third average particle size may be greater than or equal to about 1 micrometer to less than or equal to about 4 micrometers.

In various aspects, the present disclosure provides a composite electrode for an electrochemical cell that cycles lithium ions. The composite electrode may include greater than or equal to about 10 wt. % to less than or equal to about 40 wt. % of a first electroactive material and greater than or equal to about 10 wt. % to less than or equal to about 40 wt. % of a second electroactive material. The first electroactive material may have a first specific capacity, and the second electroactive material may have a second specific capacity that is less than the first specific capacity. For example, the first specific capacity may be greater than or equal to about 1,000 mAh/g to less than or equal to about 3,600 mAh/g, and the second specific capacity may be greater than or equal to about 250 mAh/g to less than or equal to about 400 mAh/g. The first electroactive material may have a first average particle size, and the second electroactive material may have a second average particle size. The second average particle size may be comparable with the first average particle size. For example, the second average particle size may be no less than half the first average particle size and no greater than twice the first average particle size. In certain variations, the composite electrode may also include greater than or equal to about 20 wt. % to less than or equal to about 80 wt. % of a third electroactive material. The third electroactive material may have the same specific capacity as the second electroactive material and may have a third average particle size. The third average particle size may be greater than the first average particle size and the second average particle size.

In one aspect, the first average particle size may be greater than or equal to about 5 micrometers to less than or equal to about 12 micrometers, the second average particle size may be greater than or equal to about 8 micrometers to less than or equal to about 16 micrometers, and the third average particle size may be greater than or equal to about 15 micrometers to less than or equal to about 30 micrometers.

In one aspect, the first electroactive material may include a silicon-containing electroactive material selected from the group consisting of: SiOₓ (where 0≤x≤2), LiₓSiO (where 0≤x≤2), nanosized silicon-carbon composite, and combinations thereof. The second and third electroactive materials may include a carbonaceous-based electroactive material independently selected from the group consisting of: natural graphite, synthetic graphite, and combinations thereof.

In one aspect, the first electroactive material may include a first plurality of first electroactive material particles and a second plurality of first electroactive material particles. The first electroactive material particles of the first plurality of first electroactive material particles may have the first average particle size, and the first electroactive material particles of the second plurality of first electroactive material particles may have a fourth average particle size that is less than the first average particle size.

In one aspect, the fourth average particle size may be greater than or equal to about 1 micrometer to less than or equal to about 4 micrometers.

In various aspects, the present disclosure provides a composite electrode for an electrochemical cell that cycles lithium ions. The composite electrode may include greater than or equal to about 10 wt. % to less than or equal to about 80 wt. % of a silicon-containing electroactive material, and greater than or equal to about 20 wt. % to less than or equal to about 90 wt. % of a graphite-containing electroactive material. The silicon-containing electroactive material may include a plurality of silicon-containing electroactive material particles. The silicon-containing electroactive material particles of the plurality may have a first average particle size. The graphite-containing electroactive material may include a plurality of graphite-containing electroactive material particles. The graphite-containing electroactive-base electroactive material particles of the plurality may have a second average particle size that is no less than half the first average particle size and no greater than twice the first average particle size.

In one aspect, the plurality of graphite-containing electroactive material particles may be a first plurality of graphite-containing electroactive material particles, and the composite electrode may further include a second plurality of graphite containing electroactive material particles having a third average particle size that is greater than the first and second average particle sizes.

In one aspect, the plurality of silicon-containing electroactive material may be a first plurality of silicon-containing electroactive material, and the composite electrode may further include a second plurality of silicon-containing electroactive material having a third average particle size that is less than the first average particle size.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell having a composite electrode including two or more electroactive materials having comparative particle sizes in accordance with various aspects of the present disclosure;

FIG. 2 is a graphical illustration demonstrating the capacity retention of example cells having composite electrodes including two or more electroactive materials having comparable particle sizes in accordance with various aspects of the present disclosure;

FIG. 3A is a microscopy, cross-sectional image, at a 30 μm scale, of an example composite electrode including two or more electroactive materials having comparable particle sizes in accordance with various aspects of the present disclosure;

FIG. 3B is a microscopy, cross-sectional image, at a 10 μm scale, of an example composite electrode including two or more electroactive materials having comparable particle sizes in accordance with various aspects of the present disclosure;

FIG. 4A is a microscopy, cross-sectional image, at a 30 μm scale, of an example composite electrode including three or more electroactive materials having comparable particle sizes in accordance with various aspects of the present disclosure;

FIG. 4B is a microscopy, cross-sectional image, at a 10 μm scale, of an example composite electrode including three or more electroactive materials having comparable particle sizes in accordance with various aspects of the present disclosure;

FIG. 5A is a microscopy, cross-sectional image, at a 30 μm scale, of another example composite electrode including two or more electroactive materials having comparable particle sizes in accordance with various aspects of the present disclosure;

FIG. 5B is a microscopy, cross-sectional image, at a 10 μm scale, of another example composite electrode including two or more electroactive materials having comparable particle sizes in accordance with various aspects of the present disclosure;

FIG. 6 is a graphical illustration demonstrating the capacity retention of example cells having composite electrodes including two or more electroactive materials, where a first electroactive material has a first particle size, and the second electroactive material has a second particle size that is larger than the first particle size;

FIG. 7 is a microscopy, top-down image, at an 87.5 μm scale, of an example composite electrode including two or more electroactive materials, where a first electroactive material has a first particle size, and the second electroactive material has a second particle size that is larger than the first particle size; and

FIG. 8 is a microscopy, top-down image, at an 87.5 μm scale, of another example composite electrodes including two or more electroactive materials, where a first electroactive material has a first particle size, and the second electroactive material has a second particle size that is larger than the first particle size.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including composite electrodes including two or more electroactive materials having comparable particles sizes, and also, to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

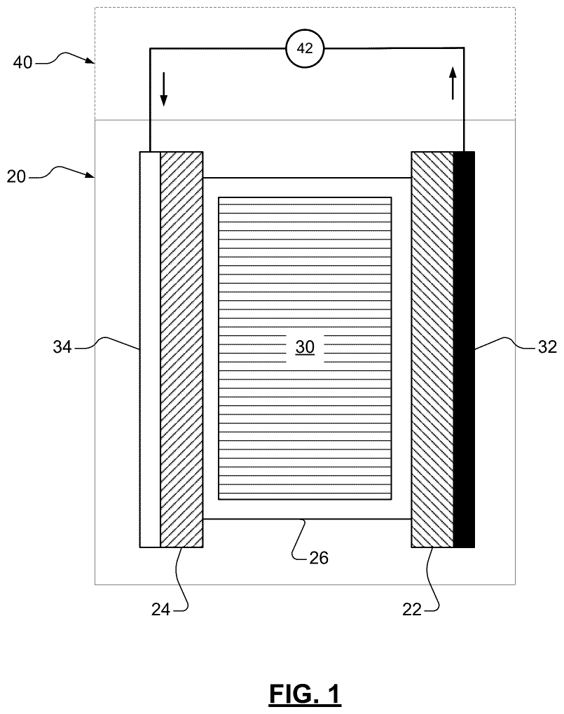

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may be a metal foil, metal grid or screen, or expanded metal comprising copper or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may be a metal foil, metal grid or screen, or expanded metal comprising aluminum or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22. In each instance, the solid-state electrolyte and/or semi-solid-state electrolyte includes the electrolyte additive as detailed above.

The positive electrode 24 is formed from a lithium-based active material that is capable of undergoing lithium intercalation and deintercalation, alloying and dealloying, or plating and stripping, while functioning as the positive terminal of a lithium-ion battery. The positive electrode 24 can be defined by a plurality of electroactive material particles. Such positive electroactive material particles may be disposed in one or more layers so as to define the three-dimensional structure of the positive electrode 24. The electrolyte 30 may be introduced, for example after cell assembly, and contained within pores of the positive electrode 24. In certain variations, the positive electrode 24 may include a plurality of solid-state electrolyte particles. In each instance, the positive electrode 24 may have an average thickness greater than or equal to about 1 μm to less than or equal to about 500 μm, and in certain aspects, optionally greater than or equal to about 10 μm to less than or equal to about 200 μm.

In various aspects, the positive electroactive material includes a layered oxide represented by LiMeO₂, where Me is a transition metal, such as cobalt (Co), nickel (Ni), manganese (Mn), iron (Fe), aluminum (Al), vanadium (V), or combinations thereof. In other variations, the positive electroactive material includes an olivine-type oxide represented by LiMePO₄, where Me is a transition metal, such as cobalt (Co), nickel (Ni), manganese (Mn), iron (Fe), aluminum (Al), vanadium (V), or combinations thereof. In still other variations, the positive electroactive material includes a monoclinic-type oxide represented by Li₃Me₂(PO₄)₃, where Me is a transition metal, such as cobalt (Co), nickel (Ni), manganese (Mn), iron (Fe), aluminum (Al), vanadium (V), or combinations thereof. In still other variations, the positive electroactive material includes a spinel-type oxide represented by LiMe₂O₄, where Me is a transition metal, such as cobalt (Co), nickel (Ni), manganese (Mn), iron (Fe), aluminum (Al), vanadium (V), or combinations thereof. In still other variations, the positive electroactive material includes a tavorite represented by LiMeSO₄F and/or LiMePO₄F, where Me is a transition metal, such as cobalt (Co), nickel (Ni), manganese (Mn), iron (Fe), aluminum (Al), vanadium (V), or combinations thereof. In still further variations, the positive electrode is a composite electrode, and the positive electroactive material includes a combination of positive electroactive materials. For example, the positive electrode 24 may include one or more layered oxides, one or more olivine-type oxides, one or more monoclinic-type oxides, one or more spinel-type oxide, one or more tavorite, or combinations thereof.

In each variation, the positive electroactive material may be optionally intermingled (e.g., slurry casted) with an electronically conductive material (i.e. conductive additive) that provide an electron conductive path and/or a polymeric binder material that improve the structural integrity of the positive electrode 24. For example, the positive electrode 24 may include greater than or equal to about 30 wt. % to less than or equal to about 98 wt. %, and in certain aspects, optionally greater than or equal to about 60 wt. % to less than or equal to about 97 wt. %, of the positive electroactive material; greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polyacrylate (LiPAA), sodium polyacrylate (NaPAA), sodium alginate, and/or lithium alginate. Electronically conducting materials may include, for example, carbon-based materials, powdered nickel or other metal particles, or a conductive polymer. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Examples of a conductive polymer include polyaniline, polythiophene, polyacetylene, polypyrrole, and the like.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have a thickness greater than or equal to about 30 μm to less than or equal to about 500 μm, and in certain aspects, optionally greater than or equal to about 50 μm to less than or equal to about 100 μm.

In various aspects, the negative electrode 22 may be a composite electrode, and the negative electroactive material may include a combination of negative electroactive materials. For example, the negative electrode 22 may include two or more electroactive materials having different specific capacities and comparable particle sizes. For example, in certain variations, a first electroactive material may have a first specific capacity greater than or equal to about 1,000 mAh/g to less than or equal to about 3,600 mAh/g, and in certain variations, optionally greater than or equal to about 1,200 mAh/g to less than or equal to about 1,900 mAh/g; and the second electroactive material may have a second specific capacity greater than or equal to about 250 mAh/g to less than or equal to about 400 mAh/g, and in certain aspects, optionally greater than or equal to about 320 mAh/g to less than or equal to about 369 mAh/g. The first electroactive material may include a plurality of first electroactive material particles having a (first) average particle size (D₅₀) greater than or equal to about 1 μm to less than or equal to about 12 μm, optionally greater than or equal to about 5 μm to less than or equal to about 12 μm, and in certain aspects, optionally greater than or equal to about 5 μm to less than or equal to about 10 μm; and a second electroactive material may include a plurality of second electroactive material particles having a (second) average particle size (D₅₀) greater than or equal to about 1 μm to less than or equal to about 16 μm, optionally greater than or equal to about 5 μm to less than or equal to about 16 μm, optionally greater than or equal to about 5 μm to less than or equal to about 12 μm, and in certain aspects, optionally greater than or equal to about 8 μm to less than or equal to about 12 μm. The negative electrode 22 may include greater than or equal to about 1 wt. % to less than or equal to about 80 wt. %, optionally greater than or equal to about 5 wt. % to less than or equal to about 30 w. %, and in certain aspects, optionally greater than or equal to about 10 wt. % to less than or equal to about 30 w. %, of the first electroactive material; and greater than or equal to about 20 wt. % to less than or equal to about 99 wt. %, optionally greater than or equal to about 70 wt. % to less than or equal to about 95 wt. %, and in certain aspects, optionally greater than or equal to about 70 wt. % to less than or equal to about 90 wt. %, of the second electroactive material.

In certain variations, at least one of the two or more electroactive materials may include two or more distinct particles sizes. For example, the second electroactive material may include a first plurality of the second electroactive material particles and a second plurality of the second electroactive material particles. The second electroactive material particles defining the first plurality of the second electroactive material particles may have the (second) average particle size (D₅₀) that is similar to the (first) average particle size (D₅₀) of the first electroactive material particles. For example, the second electroactive material particles defining the first plurality of the second electroactive material particles may have a (second) average particle size (D₅₀) greater than or equal to about 1 μm to less than or equal to about 16 μm, optionally greater than or equal to about 5 μm to less than or equal to about 12 μm, and in certain aspects, optionally greater than or equal to about 8 μm to less than or equal to about 12 μm.

The second electroactive material particles defining the second plurality of the second electroactive material particles may have a (third) average particle size (D₅₀) that is larger than the (first) average particle size (D₅₀) of the first electroactive material particles and also the (second) average particle size (D₅₀) of the second electroactive material particles defining the first plurality of second electroactive material particles. For example, the second electroactive material particles defining the second plurality of the second electroactive material particles may have a (third) average particle size (D₅₀) greater than or equal to about 14 μm to less than or equal to about 30 μm.

The negative electrode 22 may include a first amount of the first electroactive material, a second amount of the second electroactive material particles defining the first plurality of the second electroactive material, and a third amount of the second electroactive material particles defining the second plurality of the second electroactive material. In certain variations, the first amount may be about the same of the second amount. The first and second amounts may be different from the third amount. For example, the negative electrode may include greater than or equal to about 10 wt. % to less than or equal to about 40 wt. %, and in certain aspects, optionally greater than or equal to about 20 wt. % to less than or equal to about 30 wt. % of the first electroactive material; greater than or equal to about 10 wt. % to less than or equal to about 40 wt. %, and in certain aspects, optionally greater than or equal to about 20 wt. % to less than or equal to about 35 wt. %, of the second electroactive material particles defining the first plurality of the second electroactive material; and greater than or equal to about 20 wt. % to less than or equal to about 80 wt. %, and in certain aspects, optionally greater than or equal to about 35 wt. % to less than or equal to about 60 wt. %, of the second electroactive material particles defining the second plurality of the third electroactive material.

In certain variations, similar to the second electroactive material, the first electroactive material may include, alternatively or additionally, a first plurality of the first electroactive material particles and a second plurality of the first electroactive material particles, where the first plurality of the first electroactive material particles are like those first electroactive material particles detailed above, and the second plurality of the first electroactive material particles have a (fourth) average particle size (D50) that is less than the (first) average particle size (D50) of the first electroactive material particles defining the first plurality of the first electroactive material particles, and also, the (second) average particle size (D50) of the second electroactive material particles defining the first plurality of second electroactive material particles. For example, the first electroactive material particles defining the second plurality of the first electroactive material particles may have a (fourth) average particle size (D50) greater than or equal to about 1 μm to less than or equal to about 4 μm.

The negative electrode 22 may include a first amount of the first electroactive material particles defining the first plurality of the first electroactive material, a second amount of the first electroactive material particles defining the second plurality of the first electroactive material, and a third amount of the second electroactive material. For example, the negative electrode may greater than or equal to about 20 wt. % to less than or equal to about 30 wt. % of the first plurality of the first electroactive material; greater than or equal to about 20 wt. % to less than or equal to about 30 wt. % of the second electroactive material particles defining the first plurality of the second electroactive material; and greater than or equal to about 0 wt. % to less than or equal to about 60 wt. % of the second electroactive material particles defining the second plurality of the first electroactive material.

In each instance, the first electroactive material may include a silicon-containing electroactive material, including, for example, SiOₓ (where 0≤x≤2), LiₓSiO (where 0≤x≤2), and/or a nanosized silicon-carbon composite; and the second electroactive material may include a carbonaceous-based electroactive material, including, for example, natural and/or synthetic graphite. The inclusion of silicon-containing electroactive materials can help to increase energy density in the battery 20. However, when included in large amounts (e.g., greater than about 10 wt. %), the silicon-containing electroactive materials often agglomerate, which can be detrimental to cell performance. For example, direct contact of the agglomerated silicon-containing electroactive materials to the current collector 32 can cause delamination at least in part because of the large volumetric expansion of the silicon-containing electroactive materials. The inclusion of the carbonaceous-based electroactive materials including carbonaceous-based electroactive material particles having the smaller particle size (i.e., first plurality of the second electroactive material particles) and carbonaceous-based electroactive material particles having the larger particle size (i.e., second plurality of the second electroactive material particles) with the silicon-containing electroactive material can help to more uniformly distribute the silicon-containing electroactive materials in the negative electrode 22 because the smaller particles of both the silicon-containing electroactive material and the carbonaceous-based electroactive materials having the smaller particle size can co-percolate through voids between the carbonaceous-based electroactive materials having the larger particle size. Thus, the combination of the carbonaceous-based electroactive materials having the two or more distinct particles sizes with the silicon-containing electroactive material improves cell performance, as well as the adhesion between the negative electrode 22 and the negative electrode current collector 32.

In certain variations, the first and second negative electroactive materials may be intermingled with an electronically conductive material (i.e. conductive additive) that provide an electron conductive path and/or a polymeric binder material that improves the structural integrity of the negative electrode 22. For example, the negative electrode 22 may include greater than or equal to about 90 wt. % to less than or equal to about 100 wt. %, and in certain aspects, optionally greater than or equal to about 95 wt. % to less than or equal to about 98 wt. %, of the negative electroactive material (defined by the first negative electroactive material and the second negative electroactive material); greater than or equal to 0.1 wt. % to less than or equal to about 30 wt. %, optionally greater than or equal to about 0.5 wt. % to less than or equal to about 10 wt. %, and in certain aspects, optionally greater than or equal to about 1 wt. % to less than or equal to about 4 wt. %, of the electronically conducting material; and greater than or equal to about 0.1 wt. % to less than or equal to about 20 wt. %, optionally greater than or equal to about 0.5 wt. % to less than or equal to about 10 wt. %, and in certain aspects, optionally greater than or equal to about 1 wt. % to less than or equal to about 4 wt. %, of the polymeric binder material. The conductive additive and/or binder material as included in the negative electrode 22 may be the same as or different from the conductive additive and/or binder material as included in the positive electrode 24.

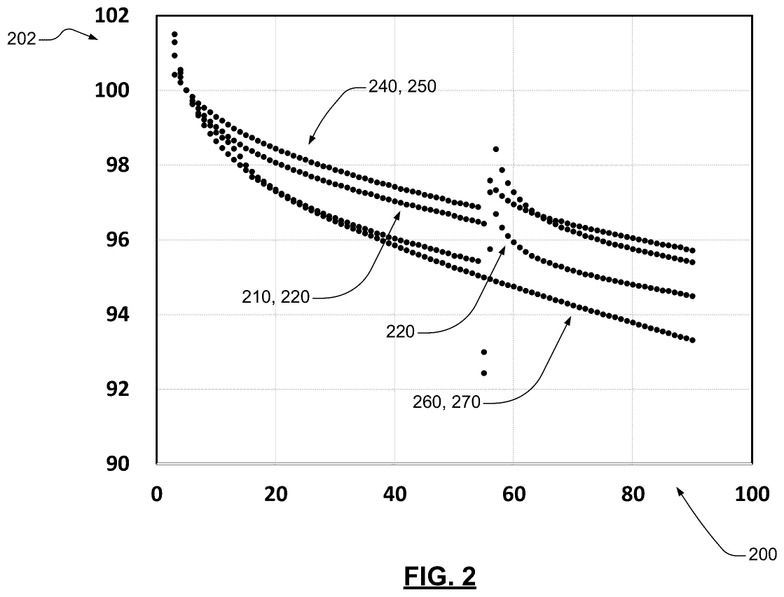

In various aspects, the present disclosure provides methods for forming composite electrodes, like the negative electrode 22 illustrated in FIG. 2. The method my include contacting (for example, mixing or blending together) the first negative electroactive material and the second negative electroactive material, for example, to form a slurry. The method may further include adding one or more conductive additives to the slurry and/or one or more binder materials to the slurry. The conductive additives and binder materials may be added concurrently or consecutively. The method may include disposing (for example, coating) the slurry onto one or more surfaces of a current collector (like the negative electrode current collector 32 illustrated in FIG. 2). The method may include drying (for example, by heating) the disposed slurry to form the negative electrode.

Certain features of the current technology are further illustrated in the following non-limiting examples.

### Example 1

Example batteries and battery cells may be prepared in accordance with various aspects of the present disclosure.

For example, a first example cell 210 may have a first negative electrode including a silicon-containing negative electroactive material (e.g., LiₓSiO, where 0≤x≤2) having an average particle size (D₅₀) of about 5 μm, a first carbonaceous-based electroactive material (e.g., SHANSHAN graphite) having an average particle size (D50) of about 10 μm, and a second carbonaceous-based electroactive material (e.g., SUPERIOR graphite) having an average particle size (D₅₀) of about 15 μm. The negative electroactive material of the first example cell 210 may include about 30 wt. % of the silicon-containing negative electroactive material, about 35 wt. % of the first carbonaceous-based electroactive material having an average particle size (D₅₀) of about 10 μm, and about 35 wt. % of the second carbonaceous-based electroactive material having an average particle size (D₅₀) of about 15 μm. The first negative electrode may include about 95 wt. % of the negative electroactive material.

Like the first example cell 210, a second example cell 220 may have a second negative electrode including a silicon-containing negative electroactive material (e.g., LiₓSiO, where 0≤x≤2) having an average particle size (D₅₀) of about 5 μm, a first carbonaceous-based electroactive material (e.g., SHANSHAN graphite) having an average particle size (D₅₀) of about 10 μm, and a second carbonaceous-based electroactive material (e.g., SUPERIOR graphite) having an average particle size (D₅₀) of about 15 μm. The negative electroactive material of the second example cell 220 may include about 30 wt. % of the silicon-containing negative electroactive material, about 35 wt. % of the first carbonaceous-based electroactive material having an average particle size (D₅₀) of about 10 μm, and about 35 wt. % of the second carbonaceous-based electroactive material having an average particle size (D₅₀) of about 15 μm. The second negative electrode may include about 95 wt. % of the negative electroactive material.

A first comparative cell 230 may have a third negative electrode including a silicon-containing negative electroactive material (e.g., LiₓSiO, where 0≤x≤2) having an average particle size (D₅₀) of about 5 μm and a carbonaceous-based electroactive material (e.g., SUPERIOR graphite) having an average particle size (D₅₀) of about 15 μm. The negative electroactive material of the first comparative cell 230 may include about 30 wt. % of the silicon-containing negative electroactive material and about 70 wt. % of the carbonaceous-based electroactive material having an average particle size (D50) of about 15 μm. The third negative electrode may include about 95 wt. % of the negative electroactive material.

A second comparative cell 240 may have a fourth negative electrode including a silicon-containing negative electroactive material (e.g., LiₓSiO, where 0≤x≤2) having an average particle size (D50) of about 5 μm and a carbonaceous-based electroactive material (e.g., SHANSHAN graphite) having an average particle size (D50) of about 10 μm. The negative electroactive material of the second comparative cell 240 may include about 30 wt. % of the silicon-containing negative electroactive material and about 70 wt. % of the carbonaceous-based electroactive material having an average particle size (D50) of about 10 μm. The fourth negative electrode may include about 95 wt. % of the negative electroactive material.

Like the second comparative cell 240, a third comparative cell 250 may have a fifth negative electrode including a silicon-containing negative electroactive material (e.g., LiₓSiO, where 0≤x≤2) having an average particle size (D50) of about 5 μm and a carbonaceous-based electroactive material (e.g., SHANSHAN graphite) having an average particle size (D50) of about 10 μm. The negative electroactive material of the third comparative cell 250 may include about 30 wt. % of the silicon-containing negative electroactive material and about 70 wt. % of the carbonaceous-based electroactive material having an average particle size (D50) of about 10 μm. The fifth negative electrode may include about 95 wt. % of the negative electroactive material.

A fourth comparative cell 260 may have a sixth negative electrode including a silicon-containing negative electroactive material (e.g., LiₓSiO, where 0≤x≤2) having an average particle size (D50) of about 5 μm and a carbonaceous-based electroactive material (e.g., HITACHI graphite) having an average particle size (D50) of about 20 μm. The negative electroactive material of the fourth comparative cell 260 may include about 30 wt. % of the silicon-containing negative electroactive material and about 70 wt. % of the carbonaceous-based electroactive material having an average particle size (D50) of about 20 μm. The sixth negative electrode may include about 95 wt. % of the negative electroactive material.

Like the fourth comparative cell 260, a fifth comparative cell 270 may have a seventh negative electrode including a silicon-containing negative electroactive material (e.g., LiₓSiO, where 0≤x≤2) having an average particle size (D50) of about 5 μm and a carbonaceous-based electroactive material (e.g., HITACHI graphite) having an average particle size (D50) of about 20 μm. The negative electroactive material of the fifth comparative cell 270 may include about 30 wt. % of the silicon-containing negative electroactive material and about 70 wt. % of the carbonaceous-based electroactive material having an average particle size (D50) of about 20 μm. The seventh negative electrode may include about 95 wt. % of the negative electroactive material.

Each of the negative electrodes 210-270 may include, in addition to the negative electroactive materials, about 1.1 wt. % of electronically conductive additives (e.g., about 1 wt. % of Super P carbon black and about 0.1 wt. % of single wall carbon nanotubes (SWCNTs)) and about 3.9 wt. % of a binder material (e.g., a 1:1 mixture of carboxymethyl cellulose (CMC) and styrene-butadiene rubber (SBR)). The following table provides a summarizing overview of the negative electroactive materials of the different cells 210-270.

| | First Electroactive | Second Electroactive Material | |
|---|---|---|---|
| Cell(s) | Material | First Plurality | Second Plurality |
| 210, | 30 wt. % of | 35 wt. % of Graphite, | 35 wt. % of Graphite, |
| 220 | LiₓSiO, 0 ≤ x ≤ 2 | D50 of about 10 μm | D50 of about 15 μm |
| | D50 of about 5 μm | | |
| 230 | 30 wt. % of | 70 wt. % of Graphite, | — |
| | LiₓSiO, 0 ≤ x ≤ 2 | D50 of about 15 μm | |
| | D50 of about 5 μm | | |
| 240, | 30 wt. % of | 70 wt. % of Graphite, | — |
| 250 | LiₓSiO, 0 ≤ x ≤ 2 | D50 of about 10 μm | |
| | D50 of about 5 μm | | |
| 260, | 30 wt. % of | 70 wt. % of Graphite, | — |
| 270 | LiₓSiO, 0 ≤ x ≤ 2 | D50 of about 20 μm | |
| | D50 of about 5 μm | | |

FIG. 2 is a graphical illustration demonstrating the capacity retention of the example cells 210, 220, 230, 240, 250, 260, and 270, where the x-axis 200 represents cycle number, and the y-axis 202 represents capacity retention (%), which is the remaining capacity as referenced to the capacity in the first cycle capacity. As illustrated, the comparative cells 240, 250, which have the best dispersion (for example, as shown by comparing the microscopy images detailed below) because of the matching between the particle sizes of the first electroactive material (e.g., LixSiO having D50 of about 5 μm) and the second electroactive material (e.g., graphite having D50 of about 10 μm), have the best cycling performance, while the example cells 230, 260, 270, which have the most agglomeration (for example, as shown by comparing the microscopy images detailed below) because of the large mismatch in particle sizes between the first electroactive material (e.g., LixSiO having D50 of about 5 μm) and the second electroactive material (e.g., graphite having D50 of about 15 μm, 20 μm, respectively), have the worst cycling performance.

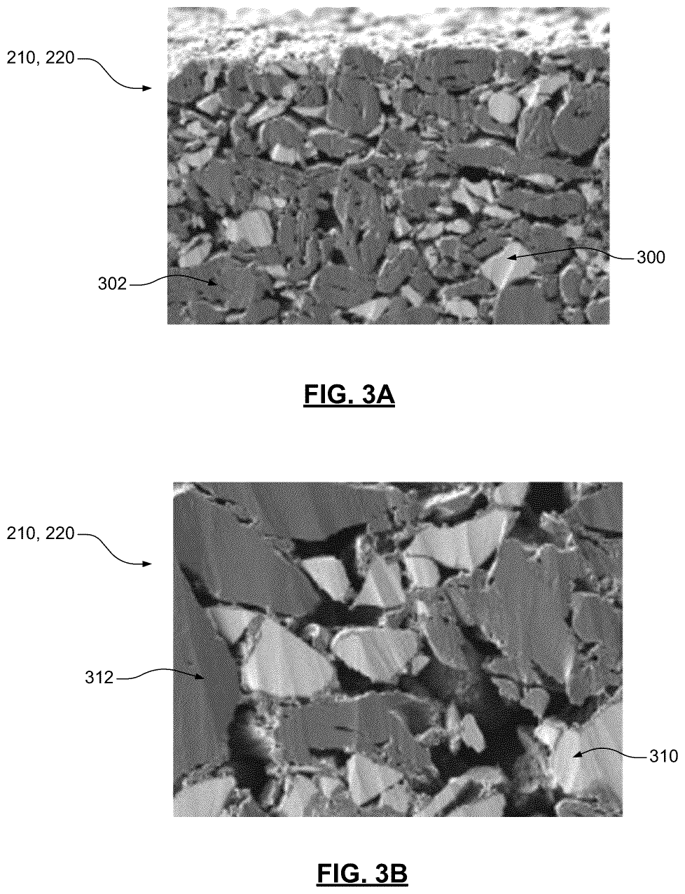

FIG. 3A is a microscopy, cross-sectional image, at a 30 μm scale, of the example cells 210, 220, where light gray particles 300 are the first electroactive material particles (e.g., silicon-containing electroactive material particles), and the darker gray particles 302 are the second electroactive material particles (e.g., graphite-containing electroactive material particles). FIG. 3B is a microscopy, cross-sectional image, at a 10 μm scale, of the example cells 240, 250, where light gray particles 310 are the first electroactive material particles (e.g., silicon-containing electroactive material particles), and the darker gray particles 312 are the second electroactive material particles (e.g., graphite-containing electroactive material particles).

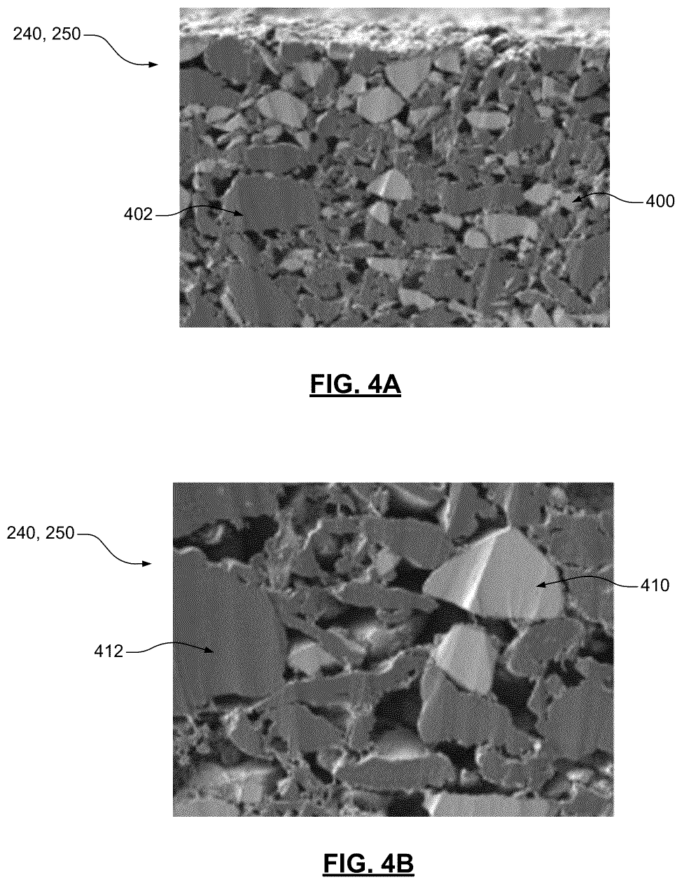

FIG. 4A is a microscopy, cross-sectional image, at a 30 μm scale, of the example cells 240, 250, where light gray particles 400 are the first electroactive material (e.g., silicon-containing electroactive material particles), and the darker gray particles 402 are the second electroactive material particles (e.g., graphite-containing electroactive material particle)s. FIG. 4B is a microscopy, cross-sectional image, at a 10 μm scale, of the example cells 240, 250, where light gray particles 410 are the first electroactive material particles (e.g., silicon-containing electroactive material particles), and the darker gray particles 412 are the second electroactive material particles (e.g., graphite-containing electroactive material particles).

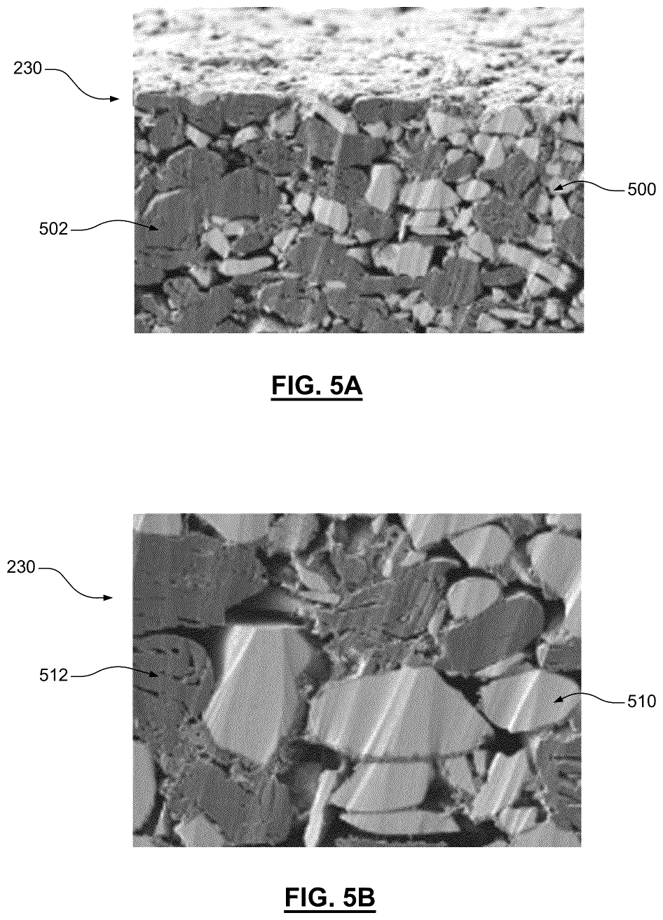

FIG. 5A is microscopy, cross-sectional image, at a 30 μm scale, of the example cell 230 where light gray particles 500 are the first electroactive material particles (e.g. silicon-containing electroactive material particles), and the darker gray particles 502 are the second electroactive material particles (e.g., graphite-containing electroactive material particles). FIG. 5B is a microscopy, cross-sectional image, at a 10 μm scale, of the example cell 230 where light gray particles 510 are the first electroactive material particles (e.g., silicon-containing electroactive material particles), and the darker gray particles 512 are the second electroactive material particles (e.g., graphite-containing electroactive material particles).

### Example 2

Example batteries and battery cells may be prepared in accordance with various aspects of the present disclosure.

For example, a first example cell 610 may have a first negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the first example cell 610 may include about 30 wt. % of the silicon-containing negative electroactive material and about 70 wt. % of the carbonaceous-based electroactive material) having an average particle size (D50) of about 20 μm. The first example cell 610 may include about 95 wt. % of the negative electroactive material.

Like the first example cell 610, a second example cell 620 may have a second negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the second example cell 620 may include about 30 wt. % of the silicon-containing negative electroactive material and about 70 wt. % of the carbonaceous-based electroactive material) having an average particle size (D50) of about 20 μm. The second example cell 620 may include about 95 wt. % of the negative electroactive material.

A third example cell 630 may have a third negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the third example cell 630 may include about 20 wt. % of the silicon-containing negative electroactive material and about 80 wt. % of the carbonaceous-based electroactive material) having an average particle size (D50) of about 20 μm. The third example cell 630 may include about 95 wt. % of the negative electroactive material.

Like the third example cell 630, a fourth example cell 640 may have a fourth negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the fourth example cell 640 may include about 20 wt. % of the silicon-containing negative electroactive material and about 80 wt. % of the carbonaceous-based electroactive material) having an average particle size (D50) of about 20 μm. The fourth example cell 640 may include about 95 wt. % of the negative electroactive material.

A fifth example cell 650 may have a fifth negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the fifth example cell 650 may include about 10 wt. % of the silicon-containing negative electroactive material and about 90 wt. % of the carbonaceous-based electroactive material) having an average particle size (D50) of about 20 μm. The fifth example cell 650 may include about 95 wt. % of the negative electroactive material.

Like the fifth example cell 650, a sixth example cell 660 may have a sixth negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the sixth example cell 660 may include about 10 wt. % of the silicon-containing negative electroactive material and about 90 wt. % of the carbonaceous-based electroactive material) having an average particle size (D50) of about 20 μm. The sixth example cell 660 may include about 95 wt. % of the negative electroactive material.

A seventh example cell 670 may have a seventh negative electrode including a silicon-containing negative electroactive material (e.g., LiₓSiO, where 0≤x≤2) having an average particle size (D50) of about 8 μm and a carbonaceous-based electroactive material (e.g., HITACHI graphite) having an average particle size (D50) of about 20 μm. The negative electroactive material of the seventh example cell 670 may include about 5.5 wt. % of the silicon-containing negative electroactive material and about 94.5 wt. % of the carbonaceous-based electroactive material) having an average particle size (D50) of about 20 μm. The seventh example cell 670 may include about 95 wt. % of the negative electroactive material.

Each of the negative electrodes 610-670 may include, in addition to the negative electroactive materials, about 1.1 wt. % of a conductive additive (e.g., about 1 wt. % of Super P and about 0.1 wt. % of carbon nanotubes) and about 3.9 wt. % of a binder material (e.g., carboxymethyl cellulose (CMC):styrene-butadiene rubber (SBR) in a 1:1 mass ratio).

A first comparative cell 680 may include about 96 wt. % of a carbonaceous-based electroactive material) having an average particle size (D50) of about 20 μm. Like the first comparative cell 680, a second comparative cell 690 may include about 96 wt. % of a carbonaceous-based electroactive material) having an average particle size (D50) of about 20 μm. The first and second comparative cells 680, 690 may each include, in addition to the negative electroactive materials, about 1.1 wt. % of a conductive additive (e.g., Super P) and about 3.9 wt. % of a binder material (e.g., 1 carboxymethyl cellulose (CMC):1 styrene-butadiene rubber (SBR)).

The following table provides a summarizing overview of the negative electroactive materials of the different cells 610-690.

| Cell(s) | First Electroactive Material | Second Electroactive Material |
|---|---|---|
| 610, | 30 wt. % of | 70 wt. % of Graphite, |
| 620 | LiₓSiO, 0 ≤ x ≤ 2 | D50 of about 20 μm |
| | D50 of about 8 μm | |
| 630, | 20 wt. % of | 80 wt. % of Graphite, |
| 640 | LiₓSiO, 0 ≤ x ≤ 2 | D50 of about 20 μm |
| | D50 of about 8 μm | |
| 650, | 10 wt. % of | 90 wt. % of Graphite, |
| 660 | LiₓSiO, 0 ≤ x ≤ 2 | D50 of about 20 μm |
| | D50 of about 8 μm | |
| 670 | 5.5 wt. % of | 94.5 wt. % of Graphite, |
| | LiₓSiO, 0 ≤ x ≤ 2 | D50 of about 20 μm |
| | D50 of about 8 μm | |
| 680, | 100 wt. % of Graphite, | — |
| 690 | D50 of about 20 μm | |

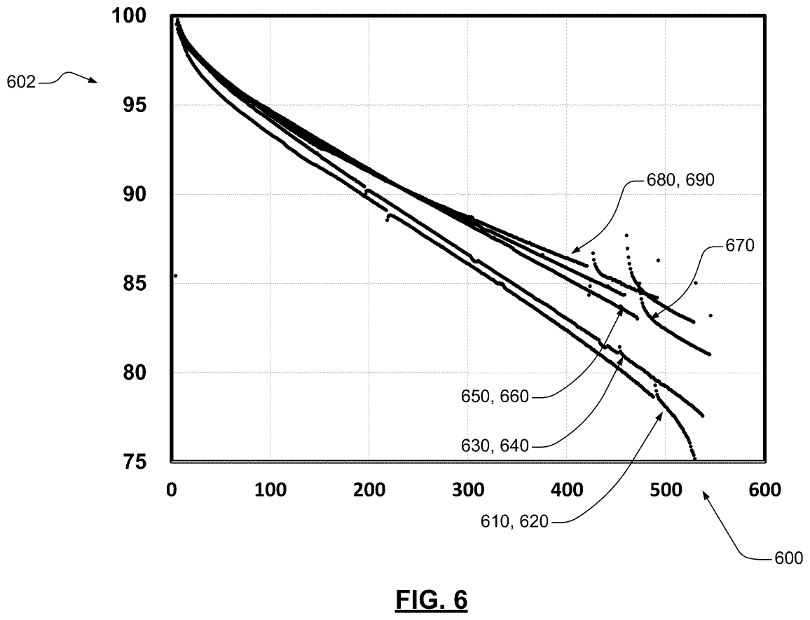

FIG. 6 is a graphical illustration demonstration, for comparison only, the capacity retention of example cells 610-670, as compared to the comparative cells 680, 690, where the x-axis 600 represents cycle number, and the y-axis 602 represents capacity retention (%). As illustrated, the cycle performance of the example cells 610-670 diminishes as the amount of the silicon-containing negative electroactive material increases at least in part because of silicon agglomeration (for example, as shown by comparing the microscopy images detailed below).

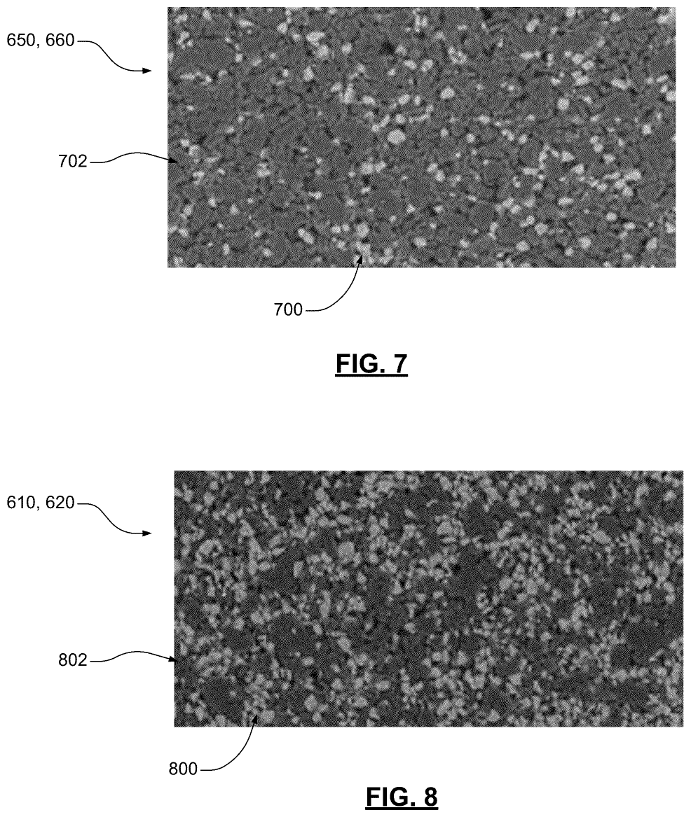

FIG. 7 is microscopy, top-down image, at an 87.5 μm scale, of the example cells 650, 660 where light gray particles 700 are the first electroactive material particles (e.g. silicon-containing electroactive material particles), and the darker gray particles 702 are the second electroactive material particles (e.g., graphite-containing electroactive material particles).

FIG. 8 is a microscopy, top-sectional image, at an 87.5 μm scale, of the example cells 610, 620 where light gray particles 800 are the first electroactive material particles (e.g., silicon-containing electroactive material particles), and the darker gray particles 802 are the second electroactive material particles (e.g., graphite-containing electroactive material particles).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A composite electrode for an electrochemical cell that cycles lithium ions, the composite electrode comprising:
a first electroactive material having a first specific capacity greater than or equal to about 1,000 mAh/g to less than or equal to about 3,600 mAh/g and a first average particle size; and
a second electroactive material having a second specific capacity greater than or equal to about 250 mAh/g to less than or equal to about 400 mAh/g and a second average particle that is no less than half the first average particle size and no greater than twice the first average particle size.

2. The composite electrode of claim 1, wherein the first average particle size is greater than or equal to 5 micrometers to less than or equal to about 12 micrometers, and the second average particle size is greater than or equal to about 8 micrometers to less than or equal to about 16 micrometers.

3. The composite electrode of claim 1, wherein the composite electrode comprises greater than or equal to about 10 wt. % to less than or equal to about 80 wt. % of the first electroactive material, and greater than or equal to about 20 wt. % to less than or equal to about 90 wt. % of the second electroactive material.

4. The composite electrode of claim 1, wherein the second electroactive material comprises a first plurality of second electroactive material particles and a second plurality of second electroactive material particles, the second electroactive material particles defining the first plurality of second electroactive material particles having the second average particle size, and the second electroactive material particles defining the second plurality of second electroactive material particles having a third average particle size that is greater than the first and second average particles sizes.

5. The composite electrode of claim 4, wherein the third average particle size is greater than or equal to about 14 micrometers to less than or equal to about 30 micrometers.

6. The composite electrode of claim 4, wherein the composite electrode comprises greater than or equal to about 10 wt. % to less than or equal to about 40 wt. % of the first electroactive material, greater than or equal to about 10 wt. % to less than or equal to about 40 wt. % of the second electroactive material particles defining the first plurality of second electroactive material particles, and greater than or equal to about 20 wt. % to less than or equal to about 80 wt. % of the second electroactive material particles defining the second plurality of second electroactive material particles.

7. The composite electrode of claim 1, wherein the first electroactive material comprises a silicon-containing electroactive material.

8. The composite electrode of claim 7, wherein the silicon-containing electroactive material is selected from the group consisting of: SiOₓ (where 0≤x≤2), LiₓSiO (where 0≤x≤2), nanosized silicon-carbon composite, and combinations thereof.

9. The composite electrode of claim 1, wherein the second electroactive material comprises a carbonaceous-based electroactive material.

10. The composite electrode of claim 9, wherein the carbonaceous-based electroactive material is selected from the group consisting of: natural graphite, synthetic graphite, and combinations thereof.

11. The composite electrode of claim 1, wherein the first electroactive material comprises a first plurality of first electroactive material particles and a second plurality of first electroactive material particles, the first electroactive material particles defining the first plurality having the first average particle size, and the first electroactive material particles defining the second plurality having a third average particle size that is smaller than the first and second average particle sizes.

12. The composite of claim 11, wherein the third average particle size is greater than or equal to about 1 micrometer to less than or equal to about 4 micrometers.

13. A composite electrode for an electrochemical cell that cycles lithium ions, the composite electrode comprising:
greater than or equal to about 10 wt. % to less than or equal to about 40 wt. % of a first electroactive material having a first specific capacity greater than or equal to about 1,000 mAh/g to less than or equal to about 3,600 mAh/g and a first average particle size;
greater than or equal to about 10 wt. % to less than or equal to about 40 wt. % of a second electroactive material having a second specific capacity greater than or equal to about 250 mAh/g to less than or equal to about 400 mAh/g and a second average particle size, the second average particle size being no less than half the first average particle size and no greater than twice the first average particle size; and
greater than or equal to about 20 wt. % to less than or equal to about 80 wt. % of a third electroactive material having the same specific capacity as the second electroactive material and having a third average particle size, the third average particle size being greater than the first average particle size and the second average particle size.

14. The composite electrode of claim 13, wherein the first average particle size is greater than or equal to about 5 micrometers to less than or equal to about 12 micrometers, the second average particle size is greater than or equal to about 8 micrometers to less than or equal to about 16 micrometers, and the third average particle size is greater than or equal to about 15 micrometers to less than or equal to about 30 micrometers.

15. The composite electrode of claim 13, wherein the first electroactive material comprises a silicon-containing electroactive material selected from the group consisting of: SiOₓ (where 0≤x≤2), LiₓSiO (where 0≤x≤2), nanosized silicon-carbon composite, and combinations thereof; and the second and third electroactive materials comprise a carbonaceous-based electroactive material independently selected from the group consisting of: natural graphite, synthetic graphite, and combinations thereof.

16. The composite electrode of claim 13, wherein the first electroactive material comprises a first plurality of first electroactive material particles and a second plurality of first electroactive material particles, the first electroactive material particles of the first plurality of first electroactive material particles having the first average particle size, and the first electroactive material particles of the second plurality of first electroactive material particles having a fourth average particle size that is less than the first average particle size.

17. The composite electrode of claim 16, wherein the fourth average particle size is greater than or equal to about 1 micrometer to less than or equal to about 4 micrometers.

18. A composite electrode for an electrochemical cell that cycles lithium ions, the composite electrode comprising:
greater than or equal to about 10 wt. % to less than or equal to about 80 wt. % of a silicon-containing electroactive material, the silicon-containing electroactive material comprising a plurality of silicon-containing electroactive material particles, the silicon-containing electroactive material particles of the plurality having a first average particle size; and
greater than or equal to about 20 wt. % to less than or equal to about 90 wt. % of a graphite-containing electroactive material, the graphite-containing electroactive material comprising a plurality of graphite-containing electroactive material particles, the graphite-containing electroactive-base electroactive material particles of the plurality having a second average particle size that is no less than half the first average particle size and no greater than twice the first average particle size.

19. The composite electrode of claim 18, wherein the plurality of graphite-containing electroactive material particles is a first plurality of graphite-containing electroactive material particles, and the composite electrode further comprises a second plurality of graphite containing electroactive material particles having a third average particle size that is greater than the first and second average particle sizes.

20. The composite electrode of claim 18, wherein the plurality of silicon-containing electroactive material is a first plurality of silicon-containing electroactive material, and the composite electrode further comprises a second plurality of silicon-containing electroactive material having a third average particle size that is less than the first average particle size.
